(19) United States
(12) Patent Application Publication
(10) Pub. No.: US 2007/0260631 A1
(43) Pub. Date: Nov. 8, 2007

(54) EMBEDDED DECISION SUPPORT

(75) Inventors: Craig Frederick Feied, Washington, DC (US); Fidrick Iskandar, Fairfax, VA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/683,844

(22) Filed: Mar. 8, 2007

Related U.S. Application Data
(60) Provisional application No. 60/780,388, filed on Mar. 9, 2006.

(51) Int. Cl. G06F 17/30

(52) U.S. Cl. 707/102; 707/E17.005

(57) ABSTRACT

Systems and methods for providing automated access to embedded decision support are disclosed. More specifically, the subject innovation provides a method for encoding decision support tools and for using those tools to adaptively provide decision support. Data can be provided to an engine in real-time and, if needed or desired, can be combined with additional existing data (e.g., from a store or entered by a user). The engine can process that data using its library of decision support tools and take action based on the results of that processing. Additionally, contextual awareness of decision support for a particular user and a specific working environment can be established and employed to trigger and/or select appropriate action.

### CROSS-REFERENCE TO RELATED APPLICATIONS

This application claims the benefit of U.S. Provisional Patent application Ser. No. 60/780,388 entitled “METHOD AND SYSTEM FOR EMBEDDED MEDICAL DECISION SUPPORT” and filed Mar. 9, 2006. The entirety of the above-noted application is incorporated by reference herein.

### BACKGROUND

A long-time effort among developers of software has been to provide decision support to the end users in a timely and effective manner. The term ‘decision support’ refers to a class of items including, but certainly not limited to, calculators, scores, algorithms, decision rules, artificial intelligence agents, and reference information. Additionally, decision support is not limited to any particular art or type of data. For example, software developers have faced the problem of providing information to health-care clinicians concerning the possible interaction between two medications a patient is taking.

Another example is the obstacle of providing information concerning the likely mortality of a patient given the existing, digitally available, clinical data. These examples are provided as illustrations only. Accordingly, it will be understood that software developers have been challenged with finding ways to provide all types of decision support, in many different contexts, in a variety of formats.

Conventional systems typically provide decision support through a process known as ‘hard-coding’. In these systems, a majority or all of the decision support technology is provided by manually hard-coding the decision support capability directly into the code of specific components. For example, a medication ordering component of a clinical information software package would have the code preventing the ordering of a medication to which a patient is allergic written directly into the medication ordering component's code.

The actions that can be taken in response to a particular decision support tool are also hard-coded into the main information system software code. This makes the modification, deletion, and addition of new decision support capabilities extremely difficult and expensive. Commonly, this code is compiled code, further complicating the maintenance and upgrading of existing capabilities.

Traditional systems offer decision support through systems that require classes of rules to be specifically structured and pre-defined. For example, these systems might have ‘medication-interaction’ decision support capability, or ‘allergy-checking’, or ‘mortality prediction’ built into them. However, each of these decision support mechanisms exists as a separate module. Thus, new capabilities cannot be added without additional, custom (and typically compiled) code written to accommodate them. This severely limits the flexibility of these traditional systems to accommodate new or previously unmet needs.

These decision support systems are custom-coded to apply not just to a specific industry (such as medicine, or flight analysis), but to a specific aspect of that industry (as in the medical examples above). Accordingly, this prohibits the application of the decision support software to any markets other than the one to which it has been custom-coded.

Moreover, in traditional systems, decision support is bound at a particular place in the software, and cannot be accessed in other environments. For example, in a medical information system, drug-interaction checking may be bound specifically to the medication ordering component. Or, the mortality prediction might be bound specifically to the patient disposition screen. Yet, decision support often has applicability throughout a specific workflow, and across different workflows. Unfortunately, these conventional systems cannot address these situations.

Binding the decision support to a particular component ensures that the user will not be able to access useful and even critical decision support information in other environments to which it would apply. In the traditional systems, decision support is bound not just to a particular part of the software environment, it is also tightly bound to a specific context in that environment. For example, in medical software, most systems are entirely bound to the context of a single patient visit. Yet, oftentimes decision support is desired to be applied to many other contexts, such as decision support that has been applied to a population of patients, or decision support that has been applied to a population of medications that have been given to patients.

Still further, traditional systems suffer from their limited capabilities for transmitting their information to the user. These systems offer a very limited methodology for providing decision support to the user; most often only a single means for doing so. For example, a system might provide notification to the user of a medication interaction by popping up an alert box on the user's computer. Yet, any one of a variety of additional actions or notification methods might be desirable.

By way of further example, it might be desirable to page the clinician's supervisors to notify them of the impending problem, but only if the clinician fails to cancel the order himself. Or it may be desirable to cause another software system to automatically cancel the order that led to the medication interaction. The inability of conventional systems to take any one or more arbitrarily simple or complex actions in response to previously set thresholds assigned to the decision support tools extremely limits their ability to affect positive change in the environments in which they are deployed.

Traditional systems are unable to tailor their notifications and responses to the specific needs of either the institution or its users. For example, many systems are hard-coded to show all alerts and notifications equally, without regard to their relevance, importance, or urgency to the general environment or specific situation or persons involved.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The subject innovation, in one aspect thereof, comprises a system that provides improved and scalable decision support capability. It provides a process whereby most any set of decision support tools can be created, encoded using any standardized method, and applied to virtually any environment and context. It provides a method for processing those decision support tools based on incoming real-time data, as well as a method whereby any digitally-initiated action or set of actions can be taken in response to the results of the tools based on any arbitrarily simple or complex rule or set of rules. In another aspect, the innovation provides a method for creating contextual awareness of decision support for a particular user and a specific working environment.

Aspects of the innovation are based on a library of tools that is external to a decision support engine's code. These tools can be abstractly defined by a user as desired using a standardized user interface or encoding component. In operation, the engine receives and processes data in real-time. In doing so, the engine can populate the decision support tools with the full diversity of available data in the information system (or with external data).

Other aspects provide mechanisms for relevant rules to be displayed in a contextual environment with or without interruption of user workflow. The decision support engine can request or take any action or set of actions, regardless of complexity, in response to the results of its decision support tool library. Under circumstances that can be arbitrarily specified, the innovation can request additional data from the user in order to utilize a specific tool.

In yet another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a decision support system in accordance with an aspect of the innovation.

FIG. 2 illustrates an exemplary data flow diagram that facilitates action based upon a decision support system in accordance with an aspect of the innovation.

FIG. 3 illustrates an example contextual awareness component that facilitates enhancing performance of decision support based upon contextual factors in accordance with an aspect of the innovation.

FIG. 4 illustrates an example block diagram of a decision engine component that maintains a tool library component, an action trigger component and a unit mapping component which facilitate prompting action in accordance with aspects of the innovation.

FIG. 5 illustrates an example support tool encoding component that facilitates generation of support tools in accordance with an aspect of the innovation.

FIG. 6 illustrates example levels in which actions can be bound in accordance with aspects of the innovation.

FIG. 7 illustrates a block diagram of a computer operable to execute the disclosed architecture.

FIG. 8 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

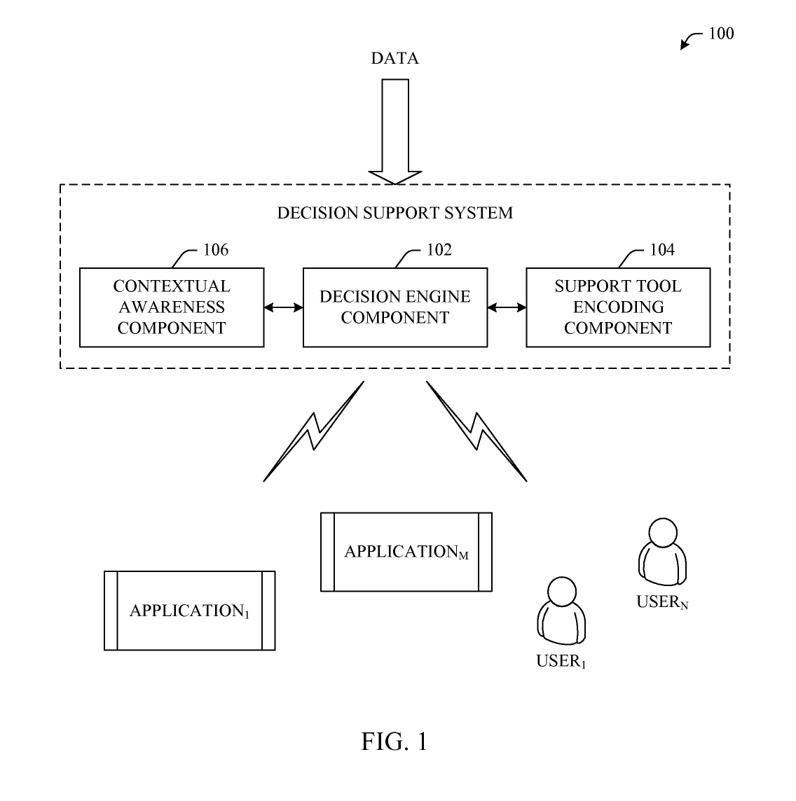

Referring initially to the drawings, FIG. 1 illustrates a system 100 that facilitates decisions support based upon most any data and/or contextual factors. Generally, system 100 can include a decision support component that can facilitate triggering an action which provides output to 1 to M applications and/or 1 to N users, where M and N are integers.

The system 100 can provide automated access to embedded decision support where a decision engine component 102 can access a tool library to locate and populate available tools. The subject innovation provides a decision support system that facilitates encoding decision support tools (e.g., via support tool encoding component 104) and for using those tools to provide decision support to applications and/or users.

As shown, data can be provided to a decision engine component 102 in real-time (or upon any desired schedule) and, if needed or desired, can be combined with additional existing data (e.g., from a store or entered by a user). The engine 102 can process that data using a library of decision support tools and take action based on the results of that processing. Additionally, a contextual awareness component 106 can be employed to provide awareness of decision support for a particular user, a specific working environment, etc.

The subject innovation can achieve these advantages through its unique architecture as illustrated in FIG. 1. As shown, the innovation provides a support tool encoding component that facilitates encoding decision support tools that populate a library that can be maintained within the decision support engine component 102. When real-time data arrives at the decision support engine, the engine 102 can auto-populate the decision support tools in its library with data, where applicable.

Thus, the tools are processed and executed by the decision support engine 102. Whenever a tool meets a displayable or actionable threshold, it can trigger an action or set of actions to a user or application. Any digitally-mediated action can be taken by the engine 102. In operation, users and institutions can set priorities for notification actions to ensure that notifications and their urgencies are appropriate to the needs of the enterprise.

Additionally, the engine 102 can elevate or lower the priority of a notification according to the rules under which the action was encoded. This can be accomplished by way of the contextual awareness component 106. As described above, conventional decision support systems required decision support to be hard-coded within the information system software. Contrary to these traditional systems, the decision support tools of the subject innovation exist in a separate resource library which can be maintained locally or external to the engine 102.

In this architecture, new decision support tools can be added, existing tools can be modified, and existing tools can be removed, without modifying and/or recompiling the underlying source code of the information system or decision support engine 102. This improves the flexibility, maintainability, and reliability of the entire system.

Unlike most conventional systems, the subject innovation is not limited to any specific or predefined class of decision support. For example, in a healthcare scenario, it is not limited specifically to medication-related decision support. It can be applied to any decision support that is amenable to an abstract encoding structure, which is to say that it can be fruitfully applied to essentially any class of decision support and decision support tools. As will be described in greater detail infra, users can employ the support tool encoding component 104 to encode tools that utilize most any combination of data in a way in order to create new, or modify existing, decision support capability.

Decision support as disclosed herein with reference to system 100 is not bound to any particular part of the user workflow or to any function in the software into which it is embedded. As a result, decision support can be instantiated most anywhere and everywhere in the user workflow and throughout the enterprise. For example, in a medical software system, decision support can be bound to a specific function for a single patient (e.g., medication ordering), to a summary display of all data about a single patient, or to a grid displaying a specific population of patients (e.g., a display of all patients seen during a particular time period). It is to be understood that these are just examples of possible bindings for the subject innovation and are not intended to limit the scope of this disclosure and/or claims appended hereto in any way.

This flexibility is a significant advantage over the traditional systems, in which decision support could not be accessed throughout the user workflow because it is tightly bound to a particular place in the user workflow, typically by binding it to a particular function in a software program, for example, the medication ordering function for a particular patient. In conventional systems, most decision support systems are not only bound to a particular function, but also bound to a particular context. For example, decision support in a typical medical decision support system is totally patient-centered.

In the subject innovation, decision support is not bound to a particular context, and therefore can be instantiated in most any context. For example, in a medical system, the context can include, but is not limited to, the context of a single patient visit, all visits for a single patient, a cohort of patients, a drug, for example, an assessment of the fraction of morphine doses versus the fraction of aspirin doses ordered through the pharmacy, or even the computer, for example, to determine if it is overheating. Virtually any row definition in any database table or view can be used to define context by the contextual awareness component 106.

Still further, the subject innovation offers a significant advantage over traditional systems in that it can take most any digitally-mediated notification action. This may include, but is not limited to, the use of ambient displays such as a slide-out pane or a designated area of the screen, as a popup dialog on the screen, as a voice stream broadcast to the user, and/or as a message displayed on another screen or an entirely different, as a text-message on the pager of a supervisor more interested in decision support information than the specific details of a particular user's work.

To the contrary, conventional systems were typically limited to only a single type of action or a very limited selection of actions that could be taken based on the results of a decision support function. Unlike these systems, under circumstances that can be arbitrarily specified, an additional action that can be taken by the subject innovation is that it can request additional data from the user (or application) in order to utilize a specific tool. One common usage would be when most, but not all, of the data of a tool is available.

For example, an Apgar score for a baby at birth requires data on the baby's color (e.g., from pink to blue), respirations, heart rate, response to nose catheter, and muscle tone. If all data elements but the muscle tone are already available, then the subject innovation can be set to request the missing data element from the user in order to perform a proper Apgar score calculation and assessment.

The decision support processing engine (e.g., engine 102) discloses significant improvement over earlier systems in that it can include a unit mapping sub-engine. In many cases, for example, in medical laboratory tests, no commonly accepted standard currently exists for the units that should be used for each result. For instance, a test might be reported in units of mg/dL (milligrams per deciliter), or g/L (gram per liter). If the test is not initially reported to the information system in the units used by the decision support tool, the test result must be converted into the unit system used by the decision support tool. In order to ensure maximum portability and interoperability between systems and environments, the decision support engine 102 can convert the units of a data element into almost any other unit system required by the decision support tool.

In one aspect, the support tool encoding component 104 can be employed to encode decision support tools using an XML (Extensible Markup Language) format that is flexible and generally abstract. While XML is mentioned, it is to be understood that any suitable language can be used to encode decision support tools in alternative aspects. The engine 102 can be coded to handle most any type of decision rule, and to expect each decision rule format file to conform to certain requirements of its type. Those requirements can include common elements, and tool-specific elements.

In this aspect, this is the only structure mandated by the overall architecture of the system 100, although specific tool types might require additional structure as the situation warrants. As used herein, ‘decision support tools’ can refer to a class of items that may include, but is certainly not limited to, calculators, scores, algorithms, decision rules, artificial intelligence agents, and reference information.

This XML example is merely one example of an instantiation of decision support tool encoding, and is not intended to represent all possible instantiations, nor are its limitations and specifications necessarily applicable to any other decision support tool encoding schema under the architecture of the innovation. In the XML example, each tag and tag attribute can represent a common element among decision tools of this type (e.g., category). Other categories may use entirely different common elements. Some of the common elements for this tool category are applicable and must be present for every tool in this category.

By way of example, a calculator without inputs would be nonsensical and valueless. Thus, each decision tool of type ‘calculator’ should have at least one input. The number of inputs and the specific inputs required for this particular tool are tool-specific and do not necessarily apply to other tools in this category or any other category. To the greatest extent possible, tool inputs are mapped to commonly accepted or well-known standards and terminologies. However, in many cases standards and terminologies do not exist for a particular element or set of elements. Therefore, mapping to standards is a preferred, but not required.

This ensures the innovation's encoding schema has the highest possible level of interoperability without sacrificing power and flexibility. As described above, the encoded tool specifications are stored in a tool ‘library’, which may be system-file based, or database-centric in nature. In either case, the set of encoded tools is not compiled directly into the engine 102. Under this architecture, new tools can be added to the library, existing tools can be improved and modified, and obsolete tools can be deleted without changing the engine 102 itself. The library facilitates maintenance, and even allows for ‘hot’ system modifications (e.g., major changes that can be applied without shutting down the functionality of the engine 102).

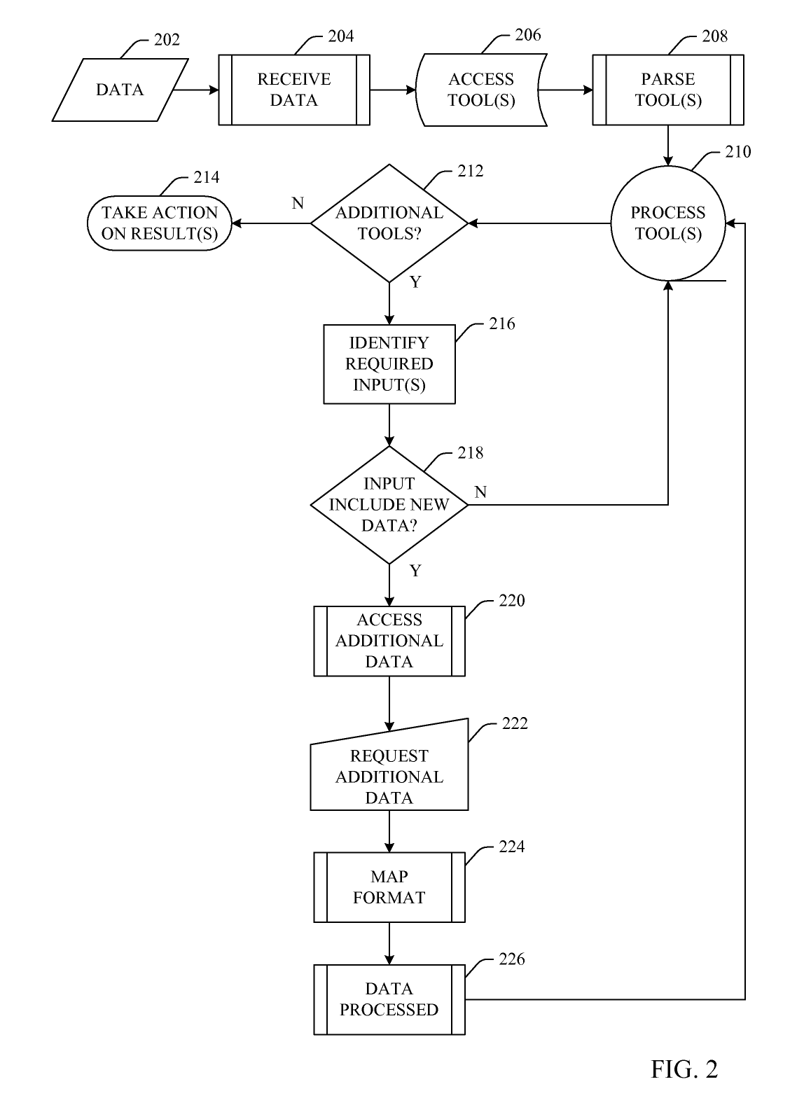

FIG. 2 illustrates a methodology of data flow of decision support in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, data is presented, in real-time or based upon a desired schedule, to a decision support engine (e.g., 102 of FIG. 1). This data presentation can occur through a variety of mechanisms. These might include, but are not limited to, the mechanisms that follow in the paragraphs infra. In an example, a decision support engine may poll for new data from a database object, a system file directory, a notification file, or any other digital structure that can be polled. Under this structure, as data is added or modified in the digital structure, a flag or other form of metadata is applied. This metadata can be crafted so that the decision support engine can, at each polling interval, determine what has changed and process it accordingly.

In aspects, the decision support engine may be bound as an object inside of another component and receive new data through its public methods. With this example structure, the host software includes the decision support engine as an object in its code, or in the code of one of its components. Consistent with standard object-oriented technology, the decision support engine has both public and private methods. The public methods can be called by the host software. It is to be understood that the public methods of the decision support engine allow the host software to pass data to the decision support engine through the parameters of its methods, and process that data.

With this architecture, not only can the decision support engine take direct action based on its results, it can also return its results to the host system so that the host can act upon those results. The decision support engine may listen (e.g., monitor) on a TCP/IP (Transmission Control Protocol/Internet Protocol) socket for incoming messages containing new data. The engine may use most any suitable protocol in this architecture including, but not limited to, HTTP (Hypertext Transfer Protocol) protocols, UDP (User Datagram Protocol) protocols, FTP (File Transfer Protocol) protocols, another well-known TCP/IP-based protocol for receiving data, or a custom protocol built on top of a TCP/IP socket infrastructure.

The decision support engine may receive data through its own interface, in which the data is directly entered by the user onto a user interface supplied by or associated with the decision support engine itself. It is to be understood that the tool specification (e.g., XML) not only provides instructions to the decision support engine for processing data inputs, it also specifies the details required to generate this user interface. The diversity of methods by which the decision support engine may be accessed allows it to be bound to virtually any component and context in the host system into which it has been embedded.

Once new data arrives at the decision support engine (at 204), the engine applies the new data to each decision support tool. This process entails several acts, as illustrated in FIG. 2. Initially, at 206, each tool in the decision support library can be accessed and parsed at 208 into a structure that can be used by the decision support engine. The tool is processed at 210.

At 212, a decision is made to determine if additional tools are to be processed. If not, at 214, action is taken on the output of the tool as a function of the data. However, if additional tools are to be processed, at 216, the required inputs for each additional tool are then identified, and compared with the new data received by the decision support engine.

Here, at 218, a decision is made to determine if the inputs include new data. If not, each tool that makes use of the information contained in the newly received data and the flow returns to process the tools by the decision support engine. Tools that do not make use of the information contained in the newly received data are not processed at this point. It is to be understood that this increases the speed and efficiency of the system.

Alternatively, the decision support tool can be specifically called with a request only to return the results of a specific tool. Once a tool is run by the engine, the first step is to gather the all the required data elements. At 220 and 222, the engine accesses existing data and combines it with the newly received data. At 224, if necessary or desired, the dataset required by the tool is then processed by the unit-mapping sub-engine to convert the existing data from its original unit system to the unit system required by the decision support tool.

Finally, the dataset is processed by the decision support engine at 226. The decision support engine can utilize a modular structure, such that each type/category of decision support tool has a module that can process it. In this manner, new functionality can be added to the decision support engine simply by adding a new module to the engine. Once processed, zero, one, or more actions may be taken by the engine, based on the encoding in the decision support tool. Typically, a result is compared to one or more threshold levels, and results that surpass a threshold will trigger one or more actions to be taken at 214.

These actions can include, but are not limited to: onscreen alerts, wireless text-messages, emails, faxes and voice telephonic transmissions, messages to another machine, messages to another component on the same machine, cascading alerts, automated ordering, and modification of the ambient environment, etc. The actions that are taken are mediated through one or more mechanisms as described below.

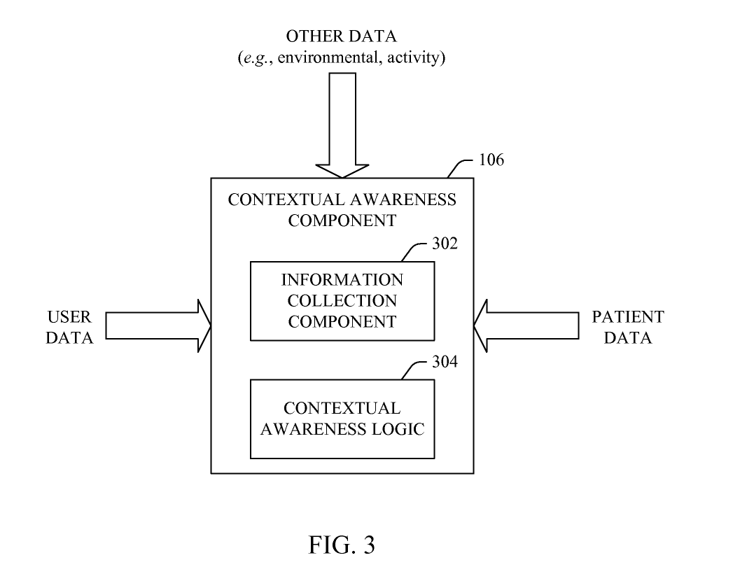

The decision support engine may initiate (e.g., trigger) an action or a series of actions by submitting them to an external job-server software program. It may initiate an action or a series of actions by returning its results to the host program, and the host program may be programmed to take the requisite actions based on those results. The decision support engine may be programmed to directly initiate an action or series of actions itself, based upon the results of its tools. Finally, the decision support engine may utilize any combination of these mechanisms. In aspects, the decision support engine can take or trigger actions of most any type. FIGS. 3, 4 and 5 that follow illustrate example components that enable the data flow as described above with reference to FIG. 2.

Referring now to FIG. 3, a block diagram of an example contextual awareness component 106 is shown. As illustrated, this component can include an information collection component 302 that facilitates establishment of a particular context which, in turn, can be used to select appropriate action. Essentially, this component 106 can create contextual awareness of the decision support environment for a particular user (or group of users), and specific working context. This contextual awareness component 106, through the use of information collection component 302, enables users to ‘subscribe’ to decision tools, for example, by manually selecting them to add them to a list of ‘important’ tools.

In an aspect, institutions can also set certain critically important decision tools to be automatically included in the list of ‘important’ tools throughout the enterprise, or for particular groups of users. The list of ‘important’ tools can exist on a per-user basis and be maintained within the contextual awareness component 106 or externally as desired.

It is to be understood that one of the notification actions for a particular decision support tool might be to automatically add its result to the list of ‘important’ tools for a user, thereby causing that user to be notified when that tool's threshold is crossed. This contextual awareness component 106 allows individual users and institutions to customize the notifications that they receive to the context of their workflow. Additionally, it also allows the decision support engine to auto-populate a user's notification list with highly relevant or critical decision support information when appropriate.

In operation, users can mark an item as ‘reviewed’ which can remove the item from ambient displays, or dismiss an interruptive alert. The failure to mark an item as ‘reviewed’ may be encoded in a decision support tool to generate new and possibly different actions.

With continued reference to FIG. 3, contextual awareness component 106 can include a contextual awareness logic component 304 that facilitates determination or inference of a context as a function of the collected information. This logic (304) can be rule-based or, alternatively, can employ machine learning and reasoning (MLR) mechanisms to establish an appropriate context. These MLR mechanisms can also be used by other components within the system (e.g., 100 of FIG. 1) in order to automatically take action based upon inference.

The subject innovation (e.g., determining contextual awareness) can employ various AI-based schemes for carrying out various aspects thereof. For example, a process for determining an appropriate context or which action to trigger based upon a particular context can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining a current context, inferring a future context, selecting a particular action based upon a determined or inferred context, etc.

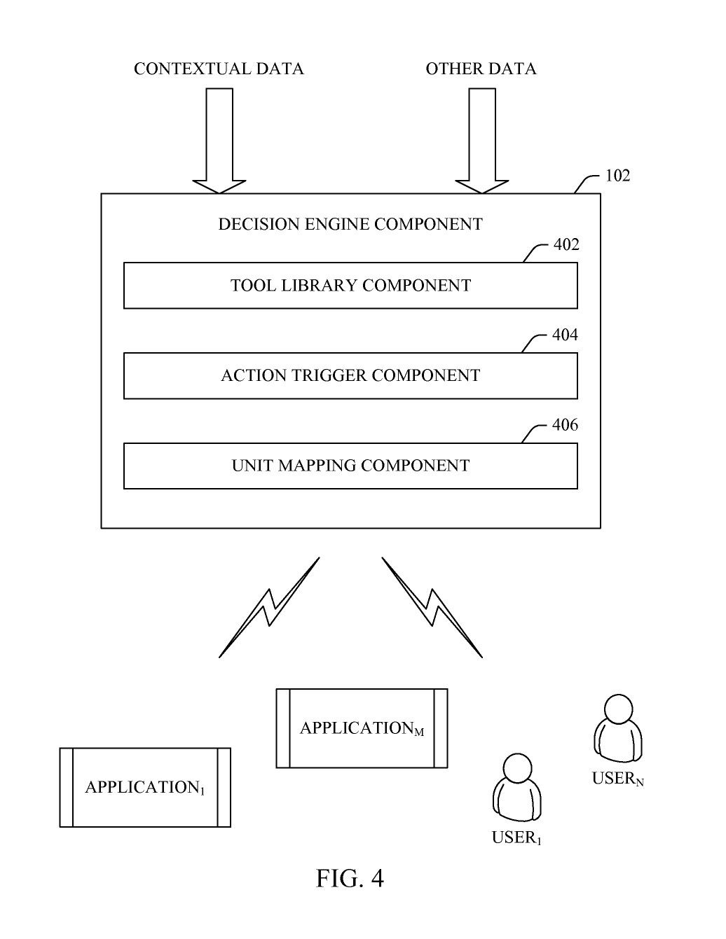

Turning now to FIG. 4, a block diagram of an example decision engine component 102 is shown. As illustrated, the example engine 102 can include a tool library component 402, an action trigger component 404 and a unit mapping component 406. Together, these components enable a variety of actions to be triggered as a function of a tool output. As well, these components provide scalability of the engine 402 such that additional tools and action triggers can be added without a need to completely recode the engine component 102. Although these subcomponents are illustrated as integral components, it is to be understood that the overall code of each subcomponent can be a separate module and not combined with the overall code of the host component.

The tool library component 402 can be integral to the decision engine component 102 as illustrated, external (not shown) or distributed between multiple locations. In a distributed scenario, the decision support tools can be accessed from a variety of locations internal and/or external. These tools can be abstractly defined by a user as desired. In operation, the engine 102 receives and processes data in real-time. Regardless if the tools are co-located (e.g., tool library 402 as shown) or external, the engine can populate the decision support tools with the full diversity of available data in the information system. As described with reference to FIG. 2 supra, available information can be supplemented with additional information input by a user.

Additionally, as shown, contextual data can be input into the decision engine component 102. The decision support engine 102 can trigger or take most any action or set of actions, regardless of complexity, in response to the output of applicable tools within its decision support tool library 106. The action trigger component 404 can facilitate prompting a specified or inferred action (e.g., notification, text message, display, alarm, electronic mail communication) as a function of the contextual awareness information.

Under circumstances that can be arbitrarily specified, the decision engine component 102 can request additional data from the user in order to utilize a specific tool. For example, if complete data is not available to process a tool, additional data can be requested, fetched, or inferred as appropriate. Similarly, if the data that is available, obtained, fetched or inferred is not in compatible units for a specific tool, as described above, the unit mapping component 406 can be employed to convert the data into suitable units such that the desired tool or set of tools can be employed.

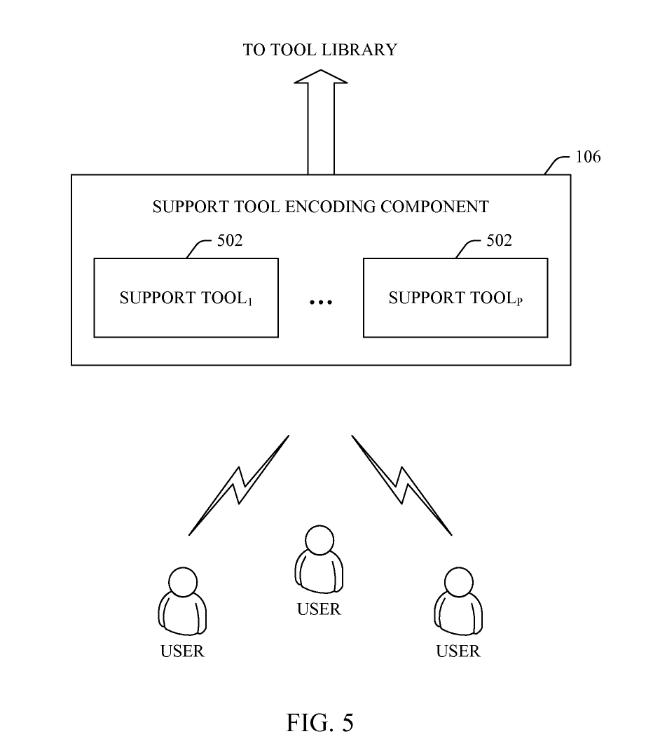

FIG. 5 illustrates an example block diagram of a support tool encoding component 106 in accordance with an aspect of the innovation. As shown, the support tool encoding component 106 enables a user, or group of users, to encode 1 to P decision support tools 502, where P is an integer. Once the tools 502 are encoded, they can be maintained within a tool library either co-located (e.g., library 402 of FIG. 4) or remote from the decision engine component (e.g., 102 of FIG. 1). Essentially, the ability to encode decision tools 502 as desired greatly enhances scalability of the innovation over that of conventional systems. As described above, conventional systems were bound by hard-coded tools which, by their nature, were costly to program and/or modify if desired. Here, tools can be encoded and accessed as desired in order to enhance and broaden the scope of use of the disclosed decision engine component (e.g., 102 of FIG. 1).

Essentially, the support tool encoding component 106 can enable an institution to be able to tailor the behavior of the decision support system (e.g., 100 of FIG. 1) to respond differently in different situations, to tailor the system to the needs of an institution, to allow users to additionally tailor that behavior to their individual needs, and to limit the ability of users to tailor the behavior of the system in contexts and environments where individual tailoring is more likely to be detrimental rather than beneficial. Due to the drawbacks, deficiencies, and disadvantages associated with previous decision support systems, there exists a need for an improved way of providing decision support for an enterprise. Moreover, there exists a need for allowing decision support authors to create new decision support tools and to define the ways in which that decision support is best expressed to the end user. Here, the support tool encoding component 106 enables personalization and/or scalability of the overall system thereby enhancing functionality of hard-coded decision support systems.

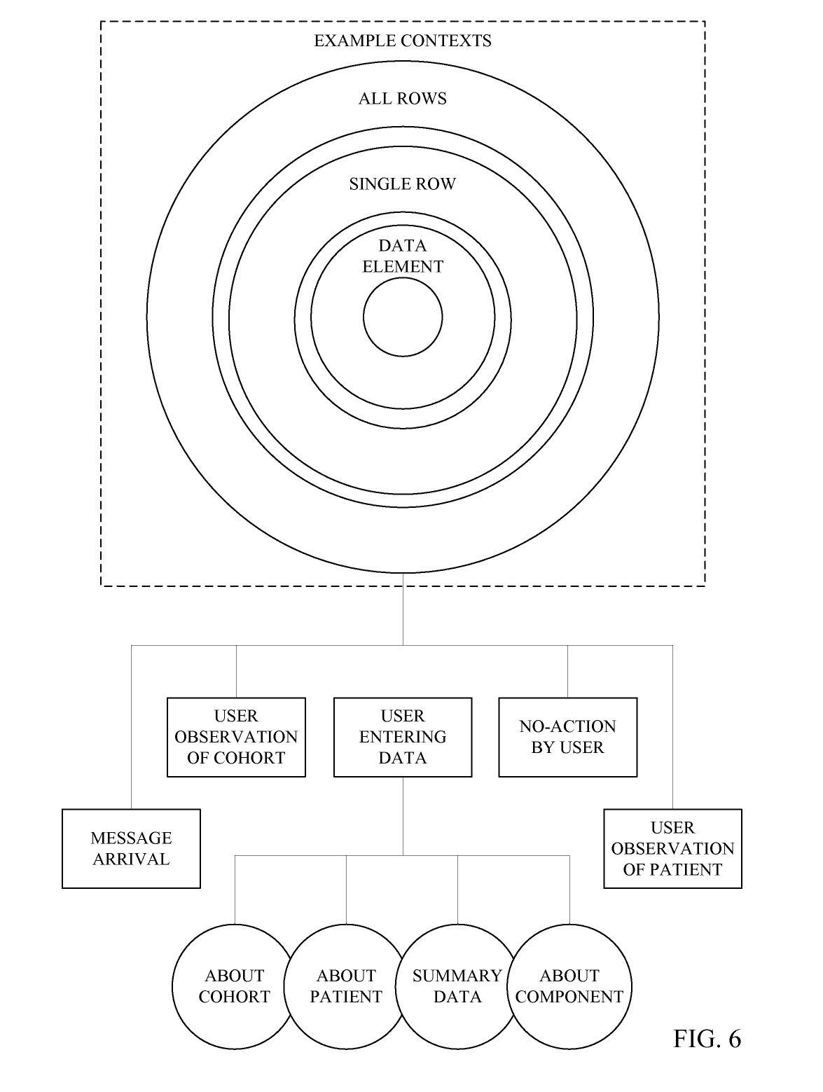

As described supra, the decision support engine can be configured to trigger most any action as a function of a tool output. These actions typically fall into one of two categories: notification actions, and corrective actions. Actions can be bound at any level, as illustrated in FIG. 6. ‘Notification’ actions are generally intended to notify users or even other machines and software programs that something noteworthy has occurred. ‘Corrective’ actions are generally intended to modify the effects that have occurred or might be predicted to occur based upon the data that was newly presented to the decision support engine.

In a health-care scenario, one example of a notification action might be a wireless text message to a doctor that a patient has a dangerously high likelihood of death over the next twelve hours. In the same scenario, an example of a corrective action might be to cancel a newly placed order to discharge a patient from the hospital when a decision support tool determines that there is a dangerously high likelihood of death over the next twelve hours.

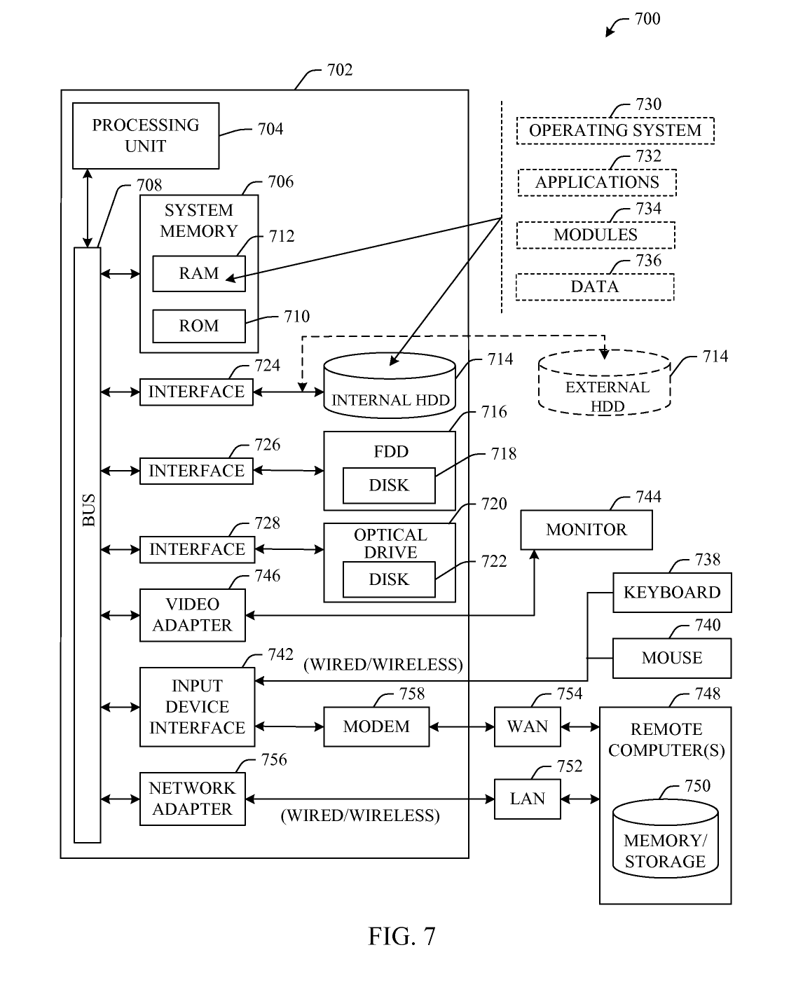

Referring now to FIG. 7, there is illustrated a block diagram of a computer operable to execute the disclosed architecture. In order to provide additional context for various aspects of the subject innovation, FIG. 7 and the following discussion are intended to provide a brief, general description of a suitable computing environment 700 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the innovation includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11 a) or 54 Mbps (802.11b) data rate, for example, or with products that contain both bands (dual band), so the networks can provide real-world performance similar to the basic 10BaseT wired Ethernet networks used in many offices.

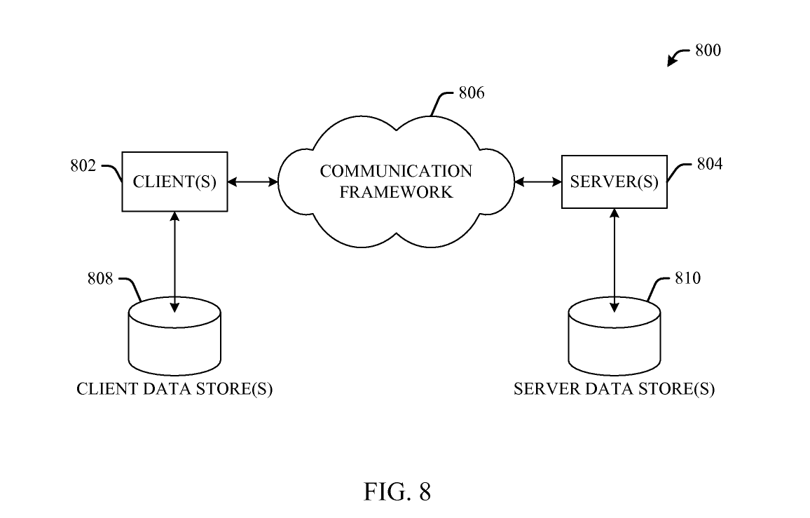

Referring now to FIG. 8, there is illustrated a schematic block diagram of an exemplary computing environment 800 in accordance with the subject innovation. The system 800 includes one or more client(s) 802. The client(s) 802 can be hardware and/or software (e.g., threads, processes, computing devices). The client(s) 802 can house cookie(s) and/or associated contextual information by employing the innovation, for example.

The system 800 also includes one or more server(s) 804. The server(s) 804 can also be hardware and/or software (e.g., threads, processes, computing devices). The servers 804 can house threads to perform transformations by employing the innovation, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates decision support, comprising:
a support tool encoding component that facilitates coding of a plurality of decision support tools; and
a decision support engine that receives data, accesses and populates a subset of the plurality of the tools with data; wherein the subset of tools generate outputs that trigger an appropriate action.

2. The system of claim 1, the data is health-related data.

3. The system of claim 1, the decision support engine requests additional data from a user to populate the subset of the plurality of tools.

4. The system of claim 1, further comprising a tool library component that maintains the plurality of coded tools for access by the decision support engine.

5. The system of claim 1, further comprising a unit mapping component that converts a subset of the data into units comprehendible by the subset of the tools.

6. The system of claim 1, further comprising a contextual awareness component that establishes a context associated with at least one of a user, patient, activity or environment; wherein the decision support engine employs the context to trigger the appropriate action.

7. The system of claim 1, the appropriate action is at least one of an onscreen alert, wireless text-message, email, fax, voice transmission, message to another machine, message to another component, cascading alert, automated ordering command, or modification of ambient environment.

8. The system of claim 1, wherein the decision support engine facilitates decision support in context of at least one of a single patient visit, all visits for a single patient, a cohort of patients, a drug, a medical procedure, or facility management.

9. The system of claim 1, further comprising a machine learning and reasoning component that employs at least one of a probabilistic and a statistical-based analysis that infers an action that a user desires to be automatically performed.

10. A computer-implemented method of decision support, comprising:
encoding a plurality of decision support tools;
receiving data;
accessing a plurality of decision support tools;
processing the plurality of decision support tools as function of the data; and
triggering an action based upon the processed decision support tools.

11. The computer-implemented method of claim 10, the data is medical-related data.

12. The computer-implemented method of claim 10, further comprising:
establishing a context; and
selecting the action as a function of the context.

13. The computer-implemented method of claim 10, further comprising:
determining that additional data is necessary to process a subset of the plurality of decision support tools; and
requesting the additional data from a user; wherein the additional data is employed in processing the subset of the plurality of decision support tools.

14. The computer-implemented method of claim 10, further comprising mapping the data into units comprehendible by a subset of the plurality of the decision support tools.

15. The computer-implemented method of claim 10, wherein the action is at least one of an onscreen alert, wireless text-message, email, fax, voice transmission, message to another machine, message to another component, cascading alert, automated ordering command, or modification of ambient environment.

16. The computer-implemented method of claim 10, further comprising maintaining a library of the plurality of decision support tools, wherein the act of accessing employs the library.

17. A computer-executable system that facilitates decision support, comprising:
means for encoding a plurality of decision support tools;
means for indexing the plurality of decision support tools;
means for receiving data;
means for accessing a subset of the decision support tools; and
means for processing the subset of the decision support tools as a function of the data.

18. The computer-executable system of claim 17, further comprising means for triggering an action as a function of output of the subset of the decision support tools.

19. The computer-executable system of claim 18, further comprising means for selecting the action as a function of a context.

20. The computer-executable system of claim 19, further comprising means for establishing the context.
